(19) United States
(12) Patent Application Publication
(10) Pub. No.: US 2009/0207428 A1
(43) Pub. Date: Aug. 20, 2009

(54) Printing System

(75) Inventors: Hiroko Tanimoto, Fuchu-shi (JP); Mamoru Takahashi, Fuchu-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: RYOBI LTD., Fuchu-shi (JP)

(21) Appl. No.: 12/370,054

(22) Filed: Feb. 12, 2009

(30) Foreign Application Priority Data
Feb. 14, 2008 (JP) 2008-033155

(51) Int. Cl. H04N 1/60; G06F 3/12

(52) U.S. Cl. 358/1.9; 358/1.15

(57) ABSTRACT

An object is to provide a printing system that is capable of reducing the time loss while keeping the function to instantly adjust the operation status of a printing press, through the structure in which even if one display part fails to operate, another display part can instantly display the information which has been displayed by the one display part. There is provided a printing system for a printing press, which includes two control devices, each including a display part for displaying plural kinds of the operation status of the printing press and an input part for setting or changing operation conditions relating to the operation status that is being displayed in the display part, the two control devices being installed with the same computer program relating to the operation conditions, and one of the two control devices being connected to the printing press, and being connected to the residual control device by wire or wireless, in which the two control devices each are provided with a mirroring function, allowing the operation condition inputted from the one control device to be rewritten into the residual control device and stored therein.

### CROSS REFERENCE TO RELATED APPLICATION

This application claims priority from Japanese Patent Application No. 2008-033155, which is incorporated herein by reference.

### BACKGROUND OF THE INVENTION

1. Field of the Invention

The present invention relates to a printing system that includes a control device that in turn includes a display part for displaying plural kinds of operation status of a printing press, and an input part for setting or changing the operation condition relating to the operation status of the printing press displayed in the display part.

2. Related Art

According to the printing system of the above type, plural kinds of operation status of the printing press, such as the printing density, the color matching, and the registration for positioning sheets relative to a plate in a sheet conveying direction and in a direction orthogonal to the sheet conveying direction are adjusted to be reached set values (target values) by inputting the operation conditions regarding these operations while checking the operation status.

According to a conventional technique, one kind of the operation status is displayed on a screen of the display part and is confirmed by visual observation of the displayed operation status; then the displayed mode is changed to a mode for inputting an operation condition relating thereto; then the operation condition is inputted therethrough; then after inputting, the mode of the screen is again changed to the mode for displaying the operation status to check whether it is matched to the inputted operation condition; where they are matched, the display part is changed to display the next operation status; and an operation condition relating thereto is set or modified in the same manner as above.

Thus, the above operation necessitates adjusting each operation status of the printing press to the set values (target values) while at the same time frequently changing the displayed mode of the screen between the status display mode for displaying the operation status and the input mode for inputting the operation condition. Accordingly, as the operation conditions to be inputted increase, the number of the times at which the mode of the screen is changed increases, which is very troublesome.

There is another proposal, in which two monitors are provided to display different modes on the screens thereof.

These two monitors comprise a monitor for use in normal operation for displaying the necessary items required for normal operation, and a monitor for use in erroneous operation for displaying the necessary items to be adjusted (e.g., Japanese Utility Model Application No. Hei-5-16310, see FIGS. 1 and 2).

### SUMMARY OF THE INVENTION

Although the structure disclosed in the above patent document can produce an advantage, in which while various kinds of the operation status of the printing press can be checked through the screen of one monitor, errors can be instantly found by displaying such errors on the screen of another monitor. However, this structure, in which two monitors are provided for respectively displaying the items necessary for the normal operation and displaying an error when it occurs, does not enable the two monitors to respectively display a status display mode for displaying the operation status of the printing press and an input mode for inputting the operation condition relating thereto. Therefore, there is still the necessity to frequently change the displayed mode for normal operation for setting in the same manner as in the conventional technique, which is very troublesome in setting.

Also, when one monitor, especially the monitor for normal operation fails to display, due to malfunction or the like, not only the checking of the operation status of the printing press but also setting or modifying of the operation condition of the printing press cannot be made. This necessitates suspending the printing operation for repairing the monitor, or replacing it with a new monitor, into which a program is installed from the scratch and the new monitor must be connected to be operated. As a result, there is a disadvantage in that great time loss might be caused due to the suspension of the printing operation.

The present invention has been made in consideration of the above problems. It is an object of the present invention to provide a printing system that is capable of reducing the time loss while keeping the function to instantly adjust the operation status of a printing press, through the structure in which even if one display part fails to operate, another display part can instantly display the information which has been displayed by the one display part.

According to the present invention, there is provided a printing system for a printing press, which includes two control devices, each including a display part for displaying plural kinds of the operation status of the printing press and an input part for setting or changing operation conditions relating to the operation status that is being displayed in the display part, said two control devices being installed with the same computer program relating to said operation conditions, and one of the two control devices being connected to the printing press, and being connected to the residual control device by wire or wireless, in which said two control devices each are provided with a mirroring function, allowing the operation condition inputted from said one control device to be rewritten into the residual control device and stored therein.

With the above printing system, a mode displayed in the display part of one control device can also be displayed in the display part of another control device. For example, the operation status of the printing press is displayed in one display part, while an input mode for inputting the operation conditions relating to this operation status is displayed in the display part of the residual control device so that the operation status of the printing press relative to the operation conditions inputted through the input mode can be instantly checked. Thus, it is possible to instantly achieve adjustment relative to the operation status of the printing press. Data inputted into the one control device is inputted into the residual control device by wire or wireless, and data previously stored in the residual control device is rewritten with this data and newly inputted data is stored in the residual control device.

A same-mode displaying prohibition means may be provided to prohibit the display parts of the one control device and the residual control device from simultaneously displaying the same display mode.

A screen of each of the plural display parts may be a touch panel screen that is capable of inputting the operation conditions by touching the screen.

According to the present invention, it is possible to enable the one display part to display the operation status of the printing press, while enable the residual display part to display the input mode for inputting the operation conditions relating to this operation status. Thus, it is possible to instantly check the operation status of the printing press relative to the operation conditions inputted through the input mode and instantly adjust the operation status of the printing press. As an additional advantage, since any one of the control devices can redundantly rewrite the same data by the mirroring function, it is possible to instantly resume the operation of the printing press by using the residual control device containing the same data, even when the one control device cannot be used due to troubles or breakdown, and thus reduce the time loss.

By providing the same-mode displaying prohibition means for prohibiting the plural display parts from simultaneously displaying the same display mode, it is possible to omit an erroneous operation of the printing press due to the simultaneous inputting, in which, for example, the same display mode is simultaneously displayed in the one display part and the residual display part and accordingly, inputting is made simultaneously to both the display parts.

When the screen of each of the display parts is a touch panel screen, there is an advantage in which the instant inputting of the operation conditions can be made as compared with the inputting of the operation conditions by using, such as a key board or mouse, since merely touching the screen is enough to input the operation condition.

### BRIEF DESCRIPTION OF THE DRAWINGS

The above, and other objects, features and advantages of the present invention will become apparent from the detailed description thereof in conjunction with the accompanying drawings wherein.

FIG. 1 is a block diagram illustrating the structure of a printing system.

FIG. 2 is a front view illustrating a mode of the screen for setting the operation conditions of the printing press.

FIG. 3 is a front view illustrating a mode of the screen for displaying the operation status of the printing press that is operated according to the operation conditions inputted in FIG. 2.

FIG. 4 is a front view illustrating another example of a mode of screen for setting the operation conditions of the printing press.

FIG. 5 is a front view illustrating the operation status of the printing press that is operated according to the operation conditions inputted in FIG. 4,

FIG. 6 is a block diagram illustrating another structure of the printing system.

### DESCRIPTION OF THE PREFERRED EMBODIMENTS

Now, the description will be made for one embodiment of a printing press of the present invention with reference to the drawings attached hereto.

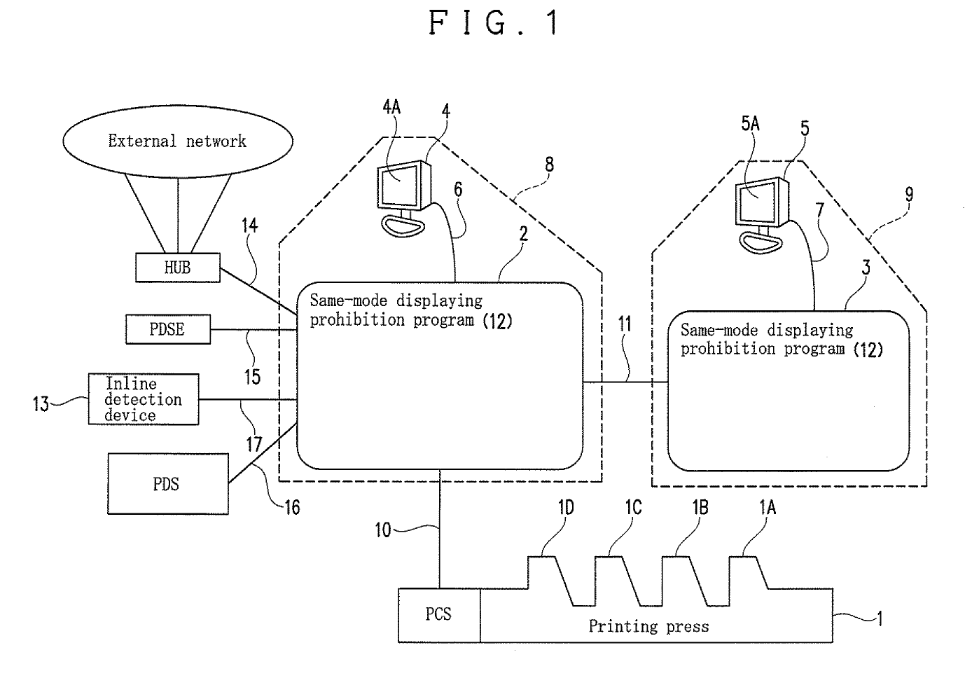

As illustrated in FIG. 1, the printing system includes a first input part 2 and a second input part 3 for setting or changing the operation conditions of a printing press 1 for printing on sheets, a first monitor 4 as a first display part and a second monitor 5 as a second display part for displaying a mode for displaying the operation status of the printing press 1 that is operated according to the operation conditions set or changed and an input mode for setting or changing the aforesaid operation conditions. In FIG. 1, a double-sided printing press equipped with four printing units 1A, 1B, 1C and 1D is illustrated as an example, in which the front side of each sheet is printed with two colors, black (Bk) and cyan (C) and then the back side thereof is printed with two colors, black (Bk) and cyan (C).

The first input part 2 is connected to the first monitor 4 with a cable 6, and the second input part 3 is connected to the second monitor 5 with a cable 7. With this arrangement, when the operation conditions are set or changed by the first input part 2, such setting or changing is made while observing an input mode displayed on the screen of the first monitor 4; and when the operation conditions are set or changed by the second input part 3, such setting or changing is made while observing an input mode displayed on the screen of the second monitor 5. The first input part 2 and the first monitor 4 together act as main components to constitute a first control device 8, and the second input part 3 and the second monitor 5 together act as main components to constitute a second control device 9.

The first input part 2 and the second input part 3 each include a central processing unit (CPU) for processing data inputted thereinto or controlling various devices, a memory for storing data, programs, etc., within a computer, a hard disk or floppy disk (FDD) as an external storage unit, and a key board as an input means for switching the displayed mode or inputting the set values on the screen.

The printing press 1 includes a print control system (PCS) for controlling the printing press 1; this print control system (PCS) is connected to the first input part 2 with a cable 10; and the first input part 2 is connected to the second input part 3 with a cable 11. With this arrangement, data transferred between the first input part 2 and the print control system (PCS) via the cable 10 is outputted to the second input part 3 via the cable 11. The data inputted by the second input part 3 is outputted to the first input part 2 via the cable 11 and is at the same time outputted to the print control system (PCS) via the cable 10 so that the printing press 1 can be operated from any one of the first input part and the second input part 3.

The same computer program regarding the operation conditions of the printing press 1 is stored in each of the memories of the input parts 2, 3 of the two control devices 8, 9, respectively, and these two control devices 8, 9 are each provided with a mirroring function, allowing data stored in the memory of the input part 2 of the control device 8 to be rewritten with data inputted from the input part 3 of the control device 9 and stored therein, or data stored in the memory of the input part 3 of the control device 9 to be rewritten with data inputted from the input part 2 of the control device 8 and stored therein. It is a matter of course that the input part 2 or 3, through which data is inputted, rewrites data currently stored in the memory thereof with this inputted data and stores the same. The control device 8 or 9 operates the printing press 1 based on the data inputted this time.

The memories of the input parts 2, 3 of the two control devices 8, 9 each further store a same-mode displaying prohibition program 12 for prohibiting one monitor 4 or 5 and another monitor 5 or 4 from simultaneously displaying the same mode. With this arrangement, it is possible to prevent erroneous or inputting, such as simultaneous inputting to the two screens since the two monitors 4, 5 do not simultaneously display the same mode.

In addition to the connection with the print control system (PCS) of the printing press 1, the input part 2 of the first control device 8 is connected to a HUB for connection with an external network, a printing density control system (PDSE) for measuring the color density of a color bar of a printed matter printed by the printing press 1, a spectrophotometer (PDS) for measuring the hue or color of a printed matter printed by the printing press 1, and an inline detection device 13 installed in the printing press 1 via cables 14, 15, 16, 17, respectively. The HUB has plural ports to which terminals are connected, and thus acts as a line concentrator constituting a LAN. A print job is automatically transferred to the control device 8 via a server or the like connected to the external network so that data representative of the number of sheets to be printed, sheet size, the ink amount, etc., can be preset in the printing press 1. The inline detection device 13 captures the image of an upcoming printed matter after printed, and the captured image data is displayed in the first monitor 4 for checking, thereby enabling changing the operation conditions according to the color density, hue or color, or the like, which tend to change during printing, and thus adjusting them to proper values.

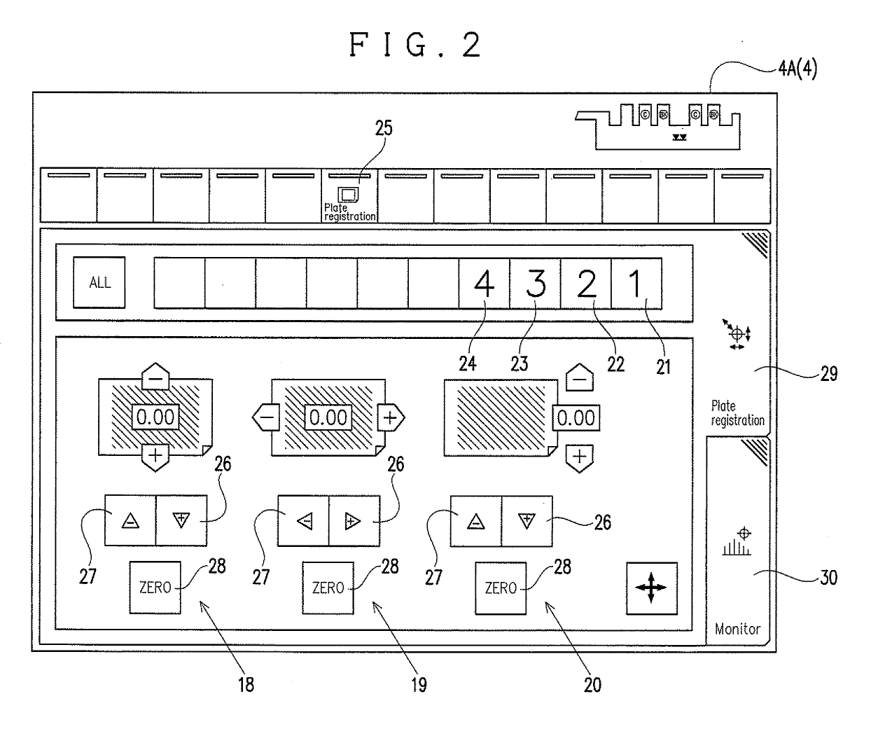

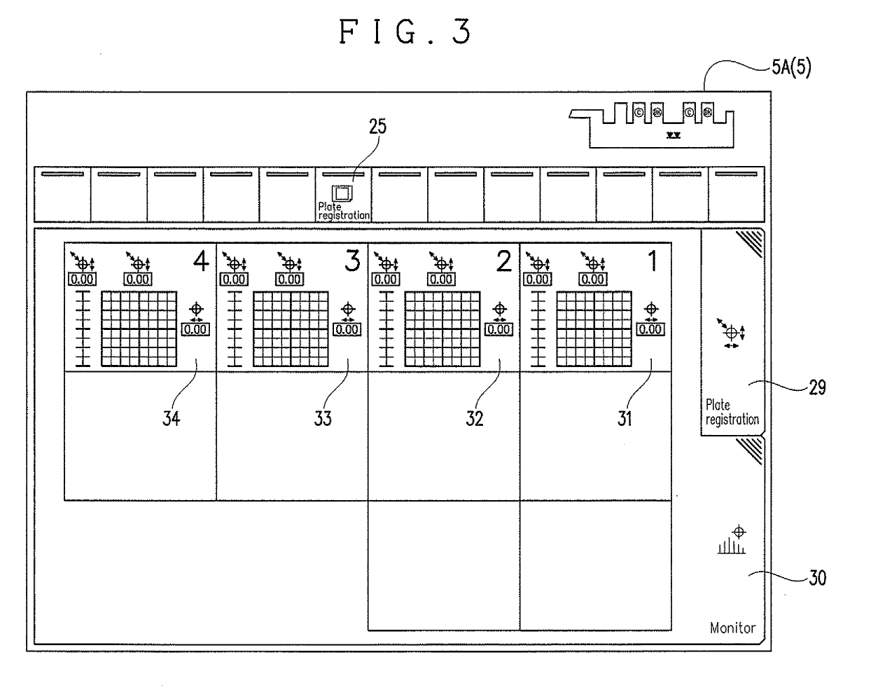

FIG. 2 illustrates a display screen 4A displayed in the first monitor 4, and FIG. 3 illustrates a display screen 5A displayed in the second monitor.

In FIG. 2, a plate registration button 25 having a square shape for setting the operation conditions of the printing press (located at the upper center of the screen) is pressed through the key board, thereby switching to the display screen 4A for adjustment of the registration of the plate. Then, a button 29 having a vertically elongated shape for adjusting the registration of the plate located at the upper right hand side of the screen is pressed through the key board, thereby enabling the display screen 4A to be displayed. Located respectively at the lower right hand side, the lower center and the lower left hand side on the this display screen 4 are a section 18 for adjusting the position of each conveyed sheet relative to the plate in the conveying direction, a section 19 for adjusting the position of each conveyed sheet relative to the plate in the lateral direction (a direction orthogonal to the conveying direction), and a section 20 for adjusting the positions of the four corners of each conveyed sheet (the posture of the sheet).

Located at substantially the center of the vertical direction of the screen and a side closer to the right end of the display screen 4A are four buttons 21, 22, 23, 24 that are selectively pressed through the key board to adjust the registration of the plate of a corresponding one of the first to fourth printing units 1A-1D. Specifically, a plus button 26, a minus button 27 and a zero (no adjustment) button 28 provided in each of the three sections 18, 19, 20 are pressed through the key board, thereby adjusting the registration of the plate of a corresponding printing unit.

In FIG. 3, a display screen 5A is displayed to display the position of each sheet relative to the plate, that is, the operation status of the printing press 1, by pressing a monitor button 30 having a vertically elongated shape located at the lower right end of the display screen 5A after pressing the plate registration button 25 displayed in the second monitor 5. In this display screen 5A, the registration positions of the first to fourth printing units 1A-1D that are operated based on the set values of the registration as adjusted can be displayed at four sections 31, 32, 33, 34 aligned in the width direction on the upper side of the display screen 5A.

Accordingly, by allowing one monitor 4 to display the display screen 44 for inputting the operation conditions while allowing another monitor 5 to display the display screen 55A for displaying the operation status of the printing press 1 that is operated based on the inputted operation conditions, it is possible to instantly confirm the operation status of the printing press 1 that is changed based on the inputted operation conditions, and thus instantly judge whether re-adjustment is to be made. Thus, there is an advantage in that the adjustment operation can be instantly made.

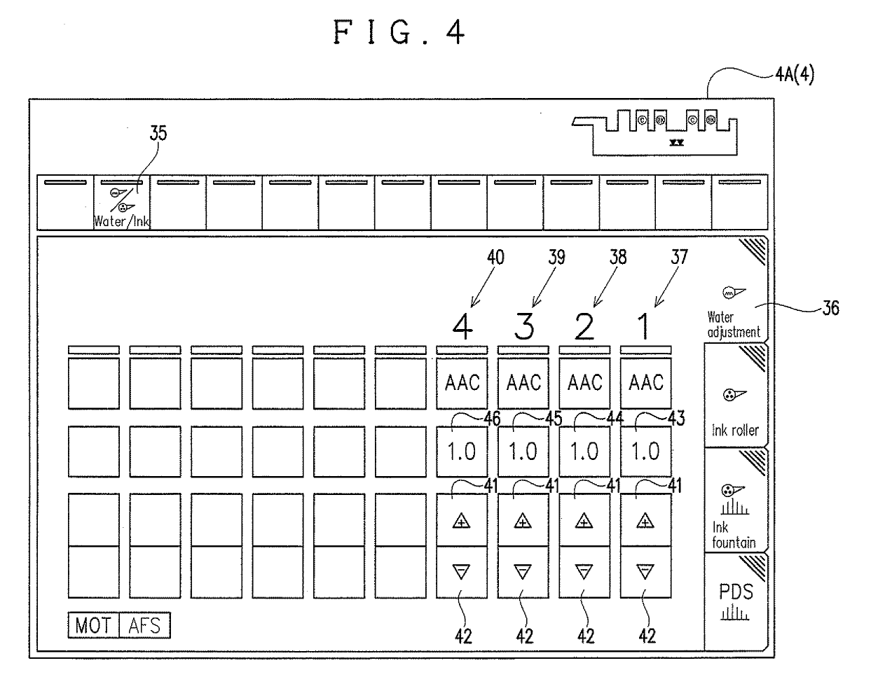

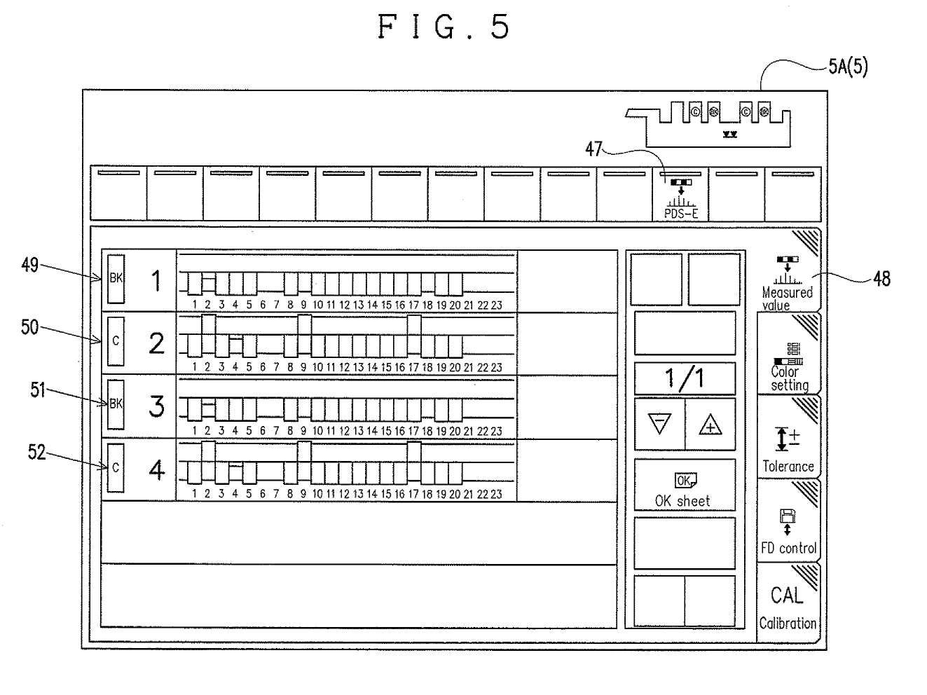

Relating to FIGS. 2 and 3, the description was made by taking, for example, the case where the adjustment of the operation conditions of the printing press is made for the adjustment of the registration position. In this respect, it is a matter of course that the adjustment may be made for the adjustment of the ratio of water and ink, as illustrated in FIG. 4. In FIG. 4, the display screen 4A of the first monitor 4 displays an input mode (operation conditions of the printing press 1) for inputting the ratio of water and ink, and in FIG. 5, the display screen 5A displays the measured value (operation status of the printing press 1) when the density of each printed matter printed after inputting the ratio of water and ink has been measured by the printing density control system (PDSE).

In FIG. 4, the display screen 4A is displayed by pressing a water/ink button 35 having a square shape located at the upper left hand side of the display screen 4A through the key board and then pressing a water adjustment button 36 having a vertically elongated shape located at the upper left end through the key board. In this display screen 4A, water adjustment sections 37, 38, 39, 40 aligned from the lower right side to the lower left side, which respectively correspond to the first printing unit 1A to the fourth printing unit 1D, are provided and each section includes a plus button 41 and a minus button 42, which are selectively pressed through the key board so as to be able to adjust the numerical values (ratio of water and ink, “1.0” is represented in this Figure) of display sections 43, 44, 45, 46.

Then, the display screen 5A as illustrated in FIG. 5 is displayed by pressing a PDS-E button 47 having a square shape and located at the upper right end of the display screen 5A of the second monitor 5 through the key board and then pressing a measured value button 48 having a vertically elongated shape located at the upper right end of the display screen 5A through the key board. Then, the respective measured color values of the first to fourth printing units 1A-1D can be represented by bar graphs 49, 50, 51, 52 located at four different heights. Upon observing this display, it is judged whether the ratio of water and ink is to be changed.

With the arrangement in which the modes displayed on the display screens 4A, 5A are changed through the key board, and the touch panel screens are employed as these display screens 4A, 5A, it is possible to produce an advantage in which the input operation can be instantly made.

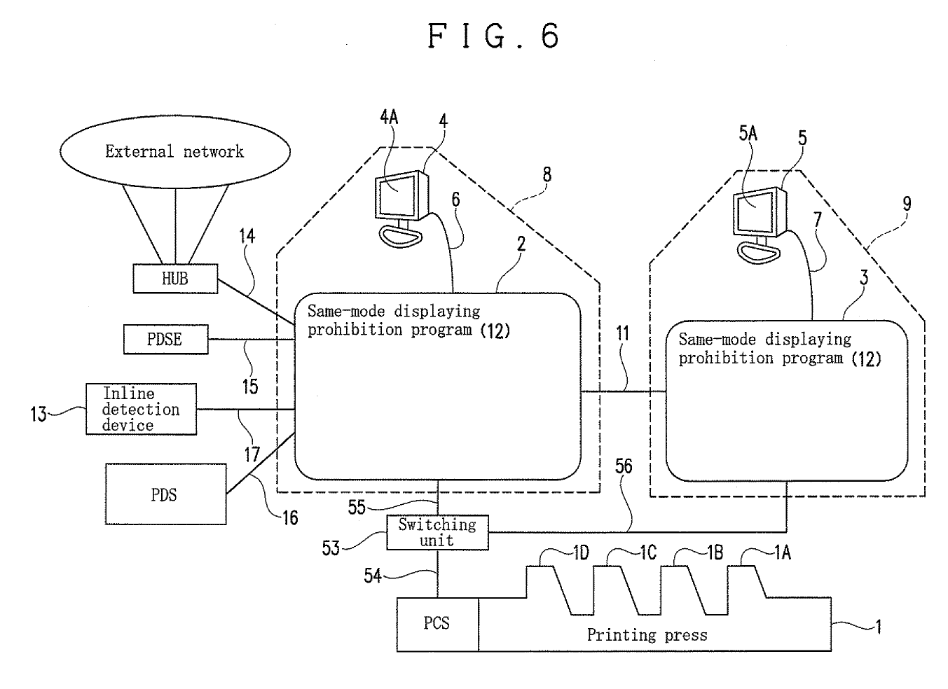

In FIG. 1, only the first control device 8 is connected to the printing press 1, but as illustrated in FIG. 6, it is possible to employ an arrangement in which the second control device 9 is also connected to the printing press 1 and a switching unit 53 is provided between the printing press 1 and the two control devices 8, 9 to switch between a first mode for connection of the printing press 1 with the first control device 8, and a second mode for connection of the printing press 1 with the second control device 9. With this connection arrangement, for example, when the first control device 8 has failed to operate, it is possible to deal with this accident by merely switching from the first mode to the second mode by the switching unit 53 according to the arrangement of FIG. 6, unlike the arrangement of FIG. 1, in which the second control device 9 must be connected to the printing press 1 by arranging an additional cable or the like. As a result, it is possible to produce an advantage in which the printing operation can be presumed in a shorter time. Describing in detail the wiring to the switching unit 53, the print control system (PCS) is connected to an input part of the switching unit 53 with a cable 54; the first input part 2 and the second input part 3 are respectively connected to free ends of two cables 55, 56 connected to two output parts of the switching unit 53; and the switching unit 53 is switched so as to be kept in electrical communication with the first input part 2 while being kept out of electrical communication with the second input part 3 in a normal condition. In a case where the second control device 9 is used by switching to the second mode, the other four cables 14-17 connected to the first control device 8 are connected to the second control device 9. The other portions, members or parts not described with reference to FIG. 6 are the same as those of FIG. 1 and are allocated the same reference codes.

The present invention is not limited in setting or adjusting manner of the operation conditions of the printing press 1 to the above embodiments. For example, the adjustment may be made for the color setting or color changing, or the sheet-conveying-speed setting or changing. It is also possible to employ an arrangement in which a display mode for the setting or changing of the operation conditions of the printing press 1 is displayed in any one of the two monitors 4, 5, while a mode for displaying the operation status of the printing press 1 is displayed in the residual monitor 4 or 5, an arrangement in which two different modes for setting or changing the different operation conditions are displayed respectively in both the two monitors 4, 5, or an arrangement in which the two different kinds of the operation status of the printing press 1 are respectively displayed in both the two monitors 4, 5. In the above embodiment, the two monitors are designed to be prohibited from displaying simultaneously the same display mode, thereby preventing erroneous input. However, according to the needs and circumstances, the same display mode may be simultaneously displayed in the two monitors.

The monitors may be a CRT of Braun tube, a liquid crystal display or EL display. In the above embodiment, a separate type personal computer is illustrated in which the input parts 2, 3 as the control devices 8, 9 are separated from the display parts 4, 5, while it is possible to employ a notebook size personal computer having an integral arrangement of the input part and the display part Alternatively, the control devices may be formed by any member other than the personal computer. The present invention is also applicable in the arrangement with the connection of three or more monitors each having the above arrangement.

It is possible to modify the structure of the printing press, for example, the number of the printing units, the presence or absence of a reversing mechanism for both-side printing, or a place for installation of the printing press, according to the needs and circumstances. For example, the present invention may be applied to a double-sided printing press by employing an arrangement in which the printing press is provided with two printing units so that when single-sided printing is made, two-color printing is made, and when a double-sided printing is made, single-color printing is made.

In the above embodiment, rewriting of data relating to the operation conditions of the printing press is made by a memory of a CPU. However, it is possible to employ an arrangement in which rewriting of data relating to the operation conditions is made by an external storage unit, such as a hard disk and a floppy disk.

The description of the above embodiment was made by, taking for example, the case where one control device 8 and another control device 9 are connected to each other by cable. Alternatively they may be connected to each other by wireless.

This specification is by no means intended to restrict the present invention to the preferred embodiments set forth therein. Various modifications to the printing system, as described herein, may be made by those skilled in the art without departing from the spirit and scope of the present invention as defined in the appended claims.

What is claimed is:

1. A printing system for a printing press, comprising two control devices, each including a display part for displaying plural kinds of the operation status of the printing press and an input part for setting or changing operation conditions relating to the operation status that is being displayed in the display part, said two control devices being installed with the same computer program relating to said operation conditions, and one of the two control devices being connected to the printing press, and being connected to the residual control device by wire or wireless, wherein said two control devices each are provided with a mirroring function, allowing the operation condition inputted from said one control device to be rewritten into the residual control device and stored therein.

2. A printing system according to claim 1, further comprising a same-mode displaying prohibition means for prohibiting the display parts of the one control device and the residual control device from simultaneously displaying the same display mode.

3. A printing system according to claim 1, wherein a screen of each of the plural display parts is a touch panel screen that is capable of inputting the operation conditions by touching the screen.

4. A printing system for a printing press, comprising three or more control devices, each including a display part for displaying plural kinds of the operation status of the printing press and an input part for setting or changing operation conditions relating to the operation status that is being displayed in the display part, said three or more control devices being installed with the same computer program relating to said operation conditions, and one of the three or more control devices being connected to the printing press, and being connected to the residual control devices by wire or wireless, wherein said three or more control devices each are provided with a mirroring function, allowing the operation condition inputted from said one control device to be rewritten into the residual control devices and stored therein.

5. A printing system according to claim 1, further comprising a same-mode displaying prohibition means for prohibiting the display parts of the one and at least one of the residual control devices from simultaneously displaying the same display mode.

6. A printing system according to claim 4, wherein a screen of each of the plural display parts is a touch panel screen that is capable of inputting the operation conditions by touching the screen.
